(19) United States
(12) Patent Application Publication
(10) Pub. No.: US 2005/0172459 A1
(43) Pub. Date: Aug. 11, 2005

(54) Cord retainer

(76) Inventors: Martin Rodney Ryan, South Lake (AU); Michael John Montgomery, Palmyra (AU); Paul Damian Callaghan, East Fremantle (AU)

Correspondence Address: MERCHANT & GOULD PC, P.O. BOX 2903, MINNEAPOLIS, MN, 55402-0903, US

(21) Appl. No.: 10/496,880

(22) PCT Filed: Nov. 28, 2002
(86) PCT No.: PCT/AU02/01607

(30) Foreign Application Priority Data
Nov. 28, 2001 (AU) PR 9124
May 1, 2002 (AU) PS 2041

(51) Int. Cl. F16G 11/00

(52) U.S. Cl. 24/115 R

(57) ABSTRACT

A cord retainer (10, 100, 140, 160) for retaining cords such as electrical power leads (32) and pneumatic hoses in an elevated position above the ground or floor. The cord retainer (10, 100, 140, 160) has a flexible web (14, 146, 168) with holes (30, 148) dimensioned to receive a cord (32) and substantially retained it against longitudinal movement with respect to the web (14, 146, 168) to the extent that the cord (32) is substantially prevented from sliding longitudinally in the hole (30, 148) under the force of its own weight or during normal installation of the cord (32), in two spaced apart cord retainers (10, 100, 140, 160). A series of frames 170, 180 and 190 are also provided for attaching the cord retainer (10, 100, 140, 160) structures on building and construction sites.

### FIELD OF THE INVENTION

The present invention relates to a cord retainer for retaining cords in an elevated position above the ground or floor. More particularly the present invention relates to an electrical lead retainer for suspending electrical leads above the ground to reduce the risk of electrical shock and electrocution. Typically, such electrical leads include mains power leads and welding power leads.

Hereinafter the present invention will be described with particular reference to cords being electrical leads although it is to be understood that it could be used with other cords, including pneumatic leads such as, for example, as used in oxy-acetylene welding. Also, hereinafter the term “lead” will generally be used as an abbreviation of the term “electrical lead”.

### BACKGROUND OF THE INVENTION

In the building industry there have been numerous deaths by electrocution on building sites attributed to the placement of electrical leads on the ground or floor. These leads may be accidentally severed or have water enter at their joins both of which can easily result in electrocution.

Accordingly safety standards have been enacted in some countries requiring that electrical leads on building sites be suspended above any working surfaces. Often tradesmen use cable ties, tape, rope or even wire to tie their electrical leads to scaffolding or the like to suspend the leads above the ground. This has the problem that the electrical lead is still in direct contact with a metal surface (in the case of scaffolding). Such suspension also is generally inconvenient for the tradesman because of the time taken to tie the electrical leads to the scaffolding. Also, the tape and cable ties cannot be reused. Further, these tying methods tend to result in damage to the electrical lead and significantly reduce the serviceable life of the electrical lead.

It is known to use a portable post type stand with a T-shaped top member to support electrical leads on building sites. Each tradesman who comes to the site suspends his leads by placing them on top of the stand. This has a number of problems. Firstly, the leads must be secured to each stand otherwise they sag too much between adjacent stands. Sometimes this is done by tying the lead about the stand—which tends to damage the lead and is dangerous. Secondly, when a tradesman wishes to retrieve his lead he has to find it amongst many other similar or identical leads placed by other tradesmen, which is difficult and time consuming. Further, once found the lead must be untangled from the other leads and untied from the top member of the stand. Still further, the stands tend to be somewhat unstable, particularly when supporting a number of leads and so the stands are prone to falling over when a tradesman attempts to remove his lead from the stand. Still further, even though the leads are secured between adjacent stands there is still a significant sagging problem, which is a hazard in itself—requiring tradesmen to stoop under the leads to avoid knocking the stands over. The sagging problem remains because the stands are moveable (that is, not fixed to the ground) and therefore incapable of allowing much tensioning of the leads between adjacent stands.

Australian Patent 716033 discloses a device for suspending cords above the ground using a resilient clip with a keyhole shaped slot defined between two jaws. A problem with this device is that the clip is resilient only in a direction radially of the cord and has no resilience axially of the cord. Accordingly, slippage of the cord in the clip is likely to happen. Hence, two adjacent ones of the device of 716033 would not be capable of allowing for tensioning of the cords, and so sagging of the cords would still be a problem.

### SUMMARY OF THE INVENTION

Therefore, it is an object of the present invention to provide a cord retainer for suspending a cord above the ground or floor.

In accordance with one aspect of the present invention there is provided a cord retainer for suspending a cord above the ground or floor, the cord retainer including a body, a clamp means depending from the body and a mounting means in operative association with the body, the clamp means being able to clamp the cord and retain it against substantial longitudinal movement with respect to the cord retainer, and the clamp means including a resilient retarding means for allowing limited displacement of the cord in its longitudinal direction.

In accordance with another aspect of the present invention there is provided a cord retainer for suspending a cord above the ground or floor, the cord retainer including a body, a resilient web depending from the body and a mounting means in operative association with the body, the resilient web including at least one aperture provided with a slit extending to an outer edge of the resilient web, the slit being arranged so that the resilient web can be deformed for allowing insertion of the cord into the aperture via the slit and therein the cord is substantially retained against longitudinal movement with respect to the resilient web, and the mounting means enabling the body to be suspended above the ground or floor.

In the context of the present invention the cord is retained against substantially longitudinal movement with respect to the web to the extent that the cord in substantially inhibited from sliding in the hole in the web, under the force of its own weight or during normal installation of the cord, into two spaced apart cord retainers. That is, in the normal use of the cord retainer and under normal loads placed on the cord there is substantially no sliding of the cord through the hole. This allows the cord to be tensioned between adjacent cord retainers for tensioning the cord against the force of its own weight and thus substantially eliminates sagging of the cord between said cord retainers.

In the context of the present invention substantial longitudinal movement of the cord with respect of the cord retainer is a movement that would allow the cord to slip with respect to the cord retainer and thereby allow the cord to sag substantially between two of the cord retainers when spaced apart.

### BRIEF DESCRIPTION OF THE DRAWING(S)

Exemplary embodiments of the present invention will now be described with reference to the accompanying drawings, in which:—

FIG. 1 is a perspective view, seen from above, of an electrical lead retainer in accordance with one aspect of the present invention, shown with an electrical lead installed in one of its holes;

FIG. 2 is a side view of the electrical lead retainer of FIG. 1;

FIG. 3 is an edge view of the electrical lead retainer of FIG. 1, shown with an electrical lead in one of its holes;

FIG. 4 is an end view of the electrical lead retainer of FIG. 1;

FIG. 5a is a part edge view of the electrical lead retainer of FIG. 3 showing insertion of a lead into a hole of the electrical lead retainer;

FIG. 5b is a part edge view of the electrical lead retainer shown in FIG. 5a showing the normal location of the lead in the hole;

FIGS. 5c and 5d are part edge views of the electrical lead retainer shown in FIG. 5a showing deflection of a web of the electrical lead retainer under the force of normal pulling of the lead in two opposing directions, such as may occur during installation of the lead between two spaced apart electrical lead retainers;

FIG. 6 is a perspective view, seen from above, of three of the electrical lead retainers of the present invention shown in use suspending an electrical lead above the ground or floor along a beam at a building site;

FIG. 7 is a side view of an electrical lead retainer in accordance with another embodiment of the present invention;

FIG. 8 is a side view of an electrical lead retainer in accordance with yet another embodiment of the present invention;

FIG. 9 is a perspective view, seen from above, of an electrical lead retainer in accordance with still another embodiment of the present invention, shown attached to a pipe;

FIG. 10 is a perspective view, seen from below, of a frame of the electrical lead retainer of FIG. 9;

FIG. 11 is a perspective view, seen from below, of an electrical lead retainer in accordance with still another embodiment of the present invention;

FIG. 12 is a perspective view, seen from above, of a frame of an electrical lead retainer in accordance with still another embodiment of the present invention; and,

FIG. 13 is a perspective view, seen from above, of a hook suitable for use with the electrical lead retainer of FIGS. 1, 7 and 8.

### DESCRIPTION OF EXEMPLARY EMBODIMENT(S)

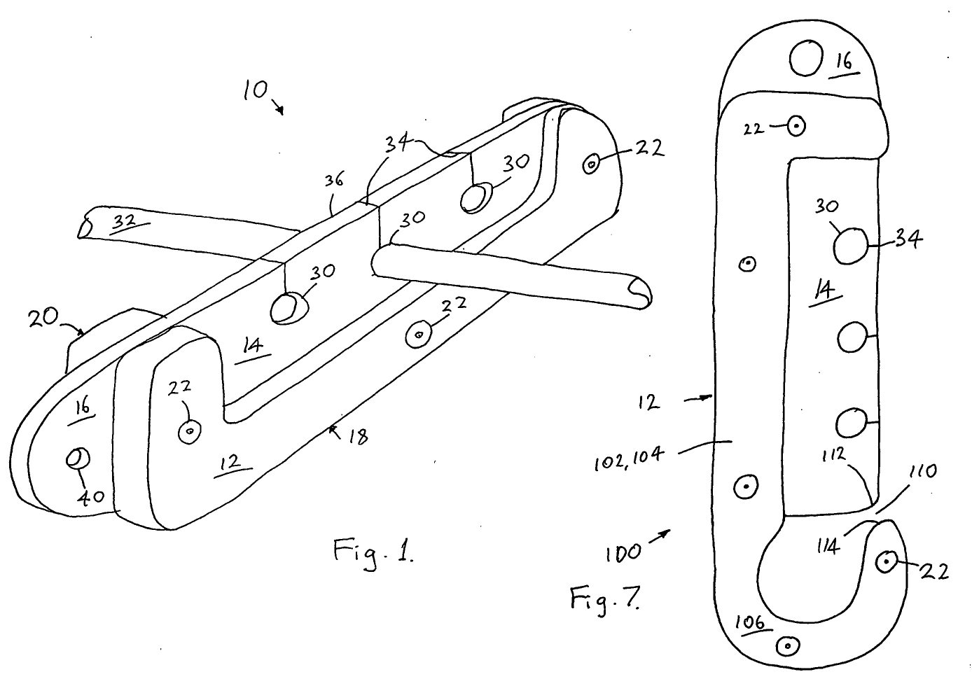

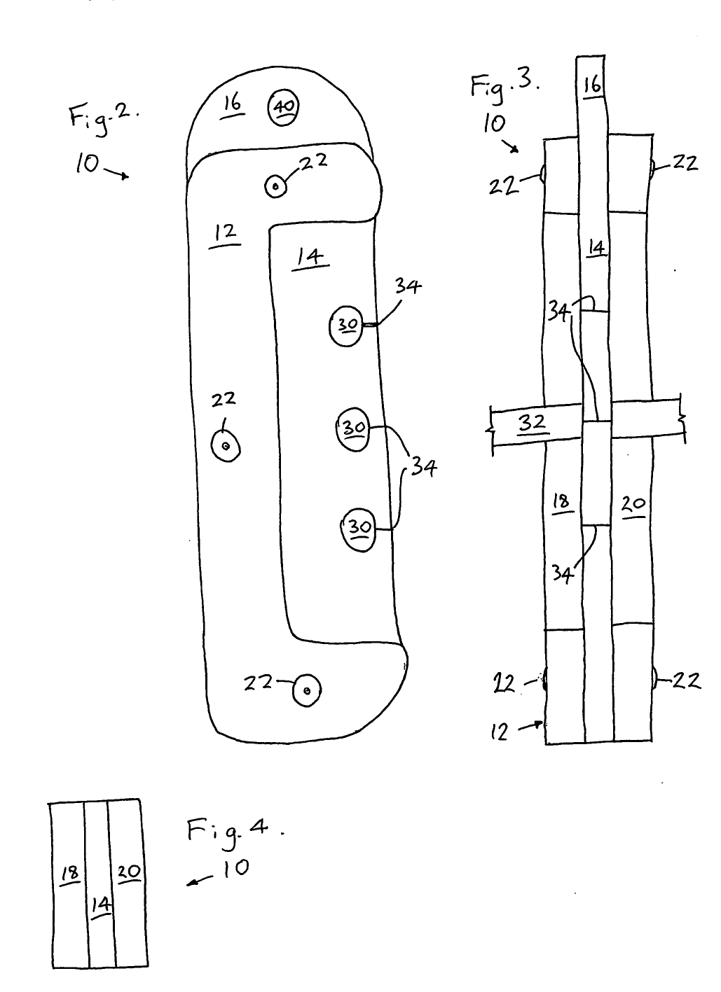

In FIGS. 1 to 4 there is shown an electrical lead retainer 10 in accordance with one aspect of the present invention. The electrical lead retainer 10 includes a body 12, a resilient web 14 depending from the body and a mounting means in the form of a mounting tab 16 in operative association with the body 12.

The body 12, in the exemplary embodiment, is substantially C-shaped when viewed in plan, substantially flat along its length and of substantially uniform depth. The body is conveniently formed of two halves 18 and 20 both having the aforementioned shape. The two halves 18 and 20 sandwich the web 14 between them and have holes that receive rivets 22, or the like fixings, to fix the two halves 18 and 20 about the web 14. A workable length for the two halves 18 and 20 is about 160 mm, a width of about 50 mm and a thickness of about 10 mm. These dimensions are only to be taken as a guide as to what can work for a conventional 240-volt mains electrical lead having a diameter of typically about 8 mm. Other dimensions do also work as described in more detail hereinafter. The thickness of the two halves 18 and 20 is preferably sufficient to make the body 12 relatively rigid so as to support the web 14.

Typically, the body 12 is made from nylon or other electrically insulating plastics materials. Typically, the plastics materials are stabilised against deterioration from UV light. Alternatively, the body 12 could be made from wood or other electrically insulating material. On the other hand, the body 12 could be made from electrically conductive metals materials, with or without electrical insulating coatings—but this is not preferred since it increases the risk of creating an electrical short to earth.

The fixings used to fix the two halves 18 and 20 about the web 14 could be made of metal or plastics materials. In applications where there is hazard from sparks plastics material rivets 22 are preferred.

Alternatively, the two halves 18 and 20 could be glued about the web 14.

It is anticipated that the body 12 could be made in a die with the two halves 18 and 20 formed as a single piece with a substantially U-shaped cross-section. In this case the flexible web 14 could be secured in the body 12 with the rivets 22. Alternatively, the inner faces of the body 12 could be provided with serrations disposed for engaging with the flexible web 14 such that the flexible web 14 could be inserted into the body 12 but inhibited from removal from the body 12 by the action of the serrations. Alternatively, the flexible web 14 could be placed in the die during the formation of the body 12 and the body moulded about the flexible body 12. In this arrangement the body 12 could be moulded through the holes otherwise provided for the rivets 22. That is to say, that the moulding process for the body 12 could include the formation of the rivets 22 through the flexible web 14 thus providing a positive keying of the flexible web 14 in the body 12.

The flexible web 14 is substantially flat along its length and is disposed to fill the region bounded by the open side of the C-shape of the body 12. The web 14 has a plurality of holes 30 formed in it in the region of the C-shape of the body 12. In the present embodiment there are 3 holes 30, although more or less holes 30 could be used. As few as one hole 30 could be used and the main limit to the maximum number of holes 30 is the length of the body 12 and the size of the holes 30.

Each hole 30 is dimensioned to snugly fit about an electrical lead 32 (as shown in FIGS. 1 and 3) so as to inhibit the electrical lead 32 from slipping longitudinally in the hole 30. Each hole 30 has a slit 34 extending to a free edge 36 of the web 14. The slit 34 allows for the lead 32 to be inserted into and removed from the hole 30.

Preferably, the diameter of the holes 30 is less than the diameter of the electrical lead 32. More preferably, the diameter of the holes 30 is between 5% to 15% less than the diameter of the holes 30. Typically, the diameter of the holes 30 is about 1 to 2 mm less than the diameter of the lead 32. Typically, 240-volt electrical leads 32 have a diameter of about 8 mm and so the diameter of the holes 30 would be between 6 to 7.5 mm, and most typically about 7 mm. However, it is known for 240 volt electrical leads 32 to have diameters from 5 to 11 mm depending on their current carrying capacity and the thickness of insulation used. It is envisaged therefore that the holes 30 could be made relatively large, say greater than 12 mm, and inserts be used to accommodate the actual size of the electrical lead 32. For example, an 8 mm lead 32 would require an insert to fill more than 4 mm, and preferably about 5 mm, radial dimension of the hole 30. The insert is wrapped around the lead 32 and pressed into the hole 30 with the lead 32.

It is to be understood that the holes 30 could be much larger than 12 mm, such as for retaining pneumatic hoses or electrical welding leads. In the case of pneumatic hoses, the holes 30 could be about 30 mm in diameter (or more). In such a case the width of the web 14 would be between say 15 to 30 mm; and the body halves 18 and 20 would also be wider to provide sufficient stiffness to the retainer 10.

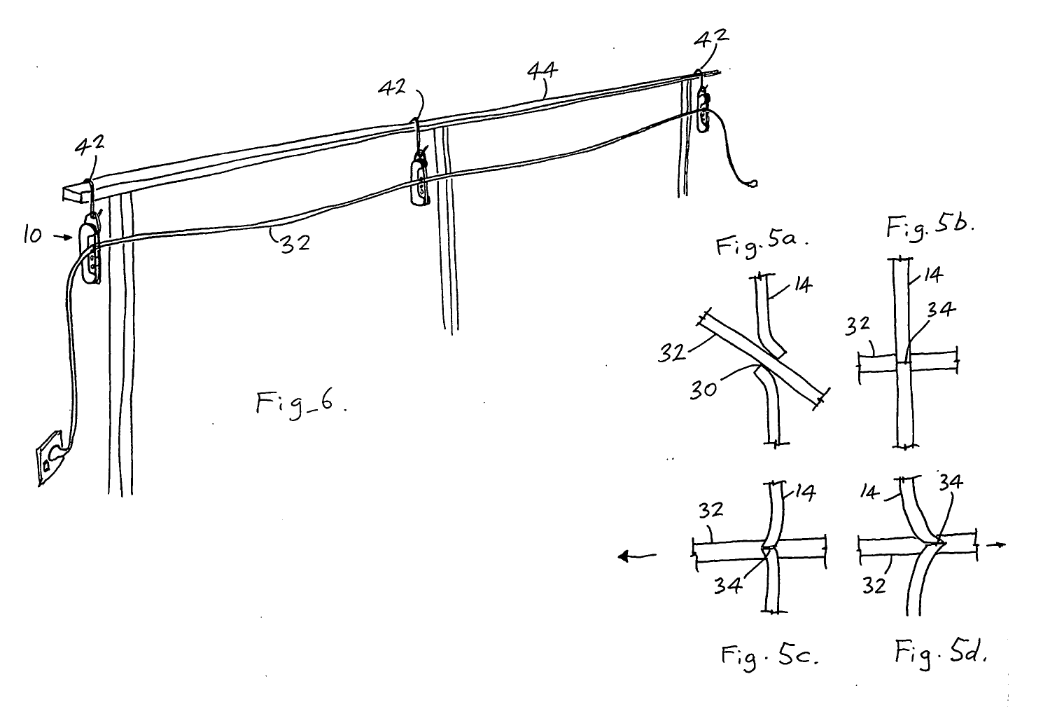

The web 14 is flexible so that the slit 34 can be opened up (as shown in FIG. 5a) to allow insertion of the lead 32 and so that the web 14 can flex in the event that there is a longitudinal force applied to the lead 32 (as shown in FIGS. 5c and d). Such forces may be applied by the force of the weight of the lead 32 suspended between two adjacent ones of the electrical lead retainers 10 (as shown in FIG. 6) and/or during the process of inserting the lead 32 into a series of the electrical lead retainers 10.

The web 14 is conveniently made from rubber materials having a thickness of between 3 mm to 30 mm, and more particularly about 8 mm—depending on the diameter and weight of the electrical lead 32 to be retained. The web 14 could also be made of a resilient plastics material, such as, for example, elastomeric polyurethane or the like. It is also envisaged that other materials could be used provided that they are capable of exerting a clamping force on the lead 32 and inhibiting it from sliding lengthwise in the hole 30.

The web 14 could be made from EDPM or cut from a conveyor belt. Such belt could have nylon reinforcing beads or the like non-conducting reinforcing.

Further, the web 14 could be made in multiple layers. For example, four thin layers of webbing could be used to make a single web 14 with a thickness of say 8 mm. We anticipate that this will increase the clamping power of the web 14 and further reduce the risk of slippage of the lead 32 as it is tensioned between two adjacent retainers 10.

It is also envisaged that the slit 34 could be replaced with a narrow slot provided that the web 14 is made of sufficiently stiff but flexible material to still allow bending for insertion of the lead whilst clamping and retaining the lead 32 to inhibit it from slipping longitudinally in the hole 30. Preferably, the width of the slit 34 is less than 15% of the diameter of the hole 30.

The mounting tab 16 has a hole 40 for attachment to a location above the ground. The mounting tab 16 is conveniently a part of the web 14. That is the tab 16 and the web 14 are two parts of the same piece of flexible material. As shown in FIGS. 6 and 13, a hook 42 could be inserted through the hole 40 and hooked over a beam 44 at a building site in order to suspend the lead 32 above the ground or floor.

Alternatively, the hole 40 in the mounting tab 16 could have permanently mounted in it one of the hooks 42 or some other device for attachment to the beam 44 or the like.

It is envisaged that the mounting tab 16 could be replaced with a clip or the like for temporary attachment about the beam 44.

It is also envisaged that the body 12, the web 14 and the mounting tab 16 could be made as a unitary piece, such as, by injection moulding. Elastomeric polyurethane could be used in such a case since it is relatively flexible when relatively thin, say about 5 to 8 mm, and relatively rigid when relatively thick, say about 15 mm or more.

It is further envisaged that the body 12 could be other than C-shaped. For example, the body 12 could have fingers that extend substantially between each of the holes 30 like a very wide toothed comb. Such an arrangement would give greater support to the web 14 in the proximity of the holes 30 and thereby allow for carrying heavier leads 32.

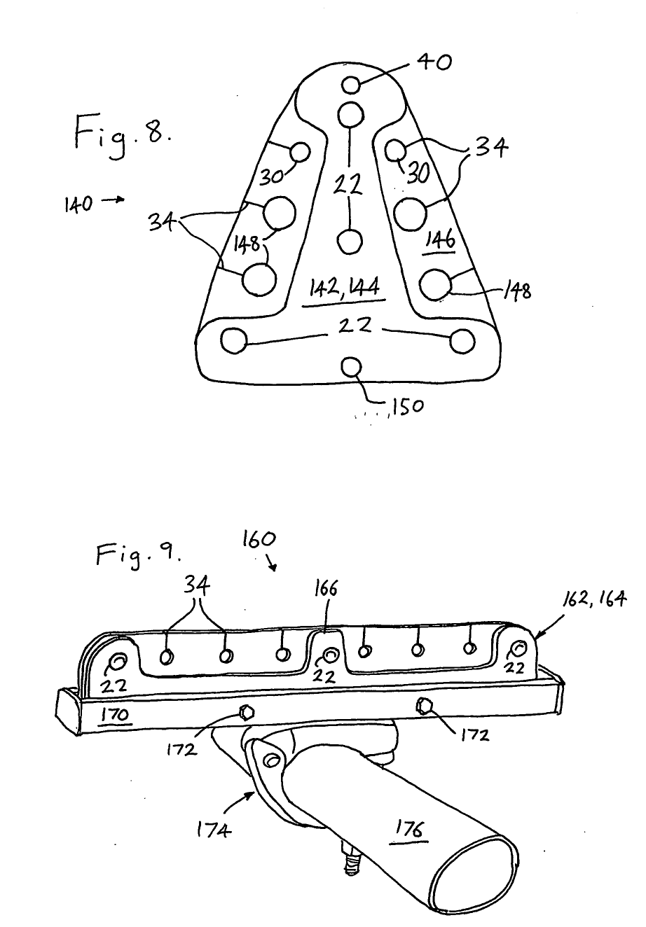

In FIG. 7 there is shown an electrical lead retainer 100, similar to the electrical lead retainer 10 and like numerals denote like parts. The electrical lead retainer 100 differs from the electrical lead retainer 10 in that it has two body halves 102 and 104 each with a hook portion 106 located at the opposite end from the tab 16.

The hook portion 106 conveniently has a mouth 110 defined by a lower end 112 of the web 14 and a distal end 114 of the hook portion 106. The mouth 110 is typically slightly narrower than the diameter of the electrical lead 32 so that force must be used to flex the lower end 112 of the web 14 when inserting the lead 32 into the hook portion 106. The narrow mouth 110 provides for secure retention of a series of loops of the lead(s) 32 with little or no risk of the loops inadvertently coming out of the hook portion 106 during the normal use of an appliance attached to the free end of the lead 32. This feature may not be preferred in some countries where there are laws preventing the coiling of excess electrical lead that is carrying electrical power. Howqever, the hook portion 106 could be used to store the free end of the lead 32 when not in use, so as to keep it off the ground or floor. Also, the hook portion 106 may also be suitable for pneumatic hoses or the like or to act as a general-purpose hook, such as, for example, for hanging a clearance lamp.

The purpose of the hook portion 106 is to retain a plurality of loops of the lead 32 so as to allow excess length of the lead 32 to be looped together and retained by the hook portion 106 at the lower end of the retainer 100.

It is envisaged that the hook portion 106 could be made relatively long with respect to the body 12 for receiving loops from a plurality of leads 32. It is also envisaged that the width of the mouth 110 could be greater than the diameter of the lead 32 to allow for easy insertion and removal of the loops of the lead(s) 32. It is further envisaged, that a closure device could be provided across the mouth 110 to mechanically close off the mouth 110 once the loops are located in the hook portion 106. Such a closure device could be in the form of a spring-loaded arm that is deflected away from the mouth 110 as the loops are inserted into the mouth 110. And the arm being able to be deflected against the spring tension by hand for removal of the loops.

In use, a plurality of the electrical lead retainers 10 are attached in spaced apart manner along a beam 44 or the like elevated structure at a building site. In the exemplary embodiment one of the hooks 42 is used to attach each of the electrical lead retainers 10 to the beam 44. The slit 34 in the web 14 is spread open and the lead 32 inserted as shown in FIG. 5a. The two parts of the web 14 on either side of the slit 34 are then released to allow the web 14 to close about and grip the lead 32 to inhibit it from sliding in the hole 30.

The lead 32 is then lifted intermediate its length and inserted into one of the holes 30 of another adjacent electrical lead retainer 10 that is spaced from the first mentioned electrical lead retainer 10. This procedure can be repeated along the entire length of the lead 32 so as to suspend it above the ground or floor. Most of the slack in the lead 32 between two adjacent ones of the electrical lead retainers 10 can be removed by holding the electrical lead retainer 10 in one hand and pulling the lead 32 longitudinally through the hole 30. It is envisaged that the lead 32 would be inserted into holes 30 that are at the same height on each of the retainers 10 so as to reduce the risk of tangling of the leads 32.

In the event that there is a substantial amount of the lead 32 left at the appliance end the retainer 100 can be used and the extra lead 32 collected in loops that can be retained in the hook portion 106. However, this may not be suitable for some voltages and in some countries.

In FIG. 8 there is shown an electrical lead retainer 140 in accordance with another embodiment of the present invention. The electrical lead retainer 140 is similar to the electrical lead retainer 10 and like numerals denote like parts. The electrical lead retainer 140 differs from the electrical lead retainer 10 in that it has two body halves 142 and 144 that are shaped like an inverted T. The electrical lead retainer 140 also has a web 146 that is substantially triangular when viewed in plan and has two sets of holes 30 along two of its three sides.

Conveniently, the holes 30 could include some larger diameter holes 148 such as for retaining high current capacity electrical power leads 32 or electrical welding leads.

The two body halves 142 and 144 also have a hole 150 located in a distal side from the holes 30 and 148 for securing retainer 140 as described hereinafter, or for attaching one of the hooks 42.

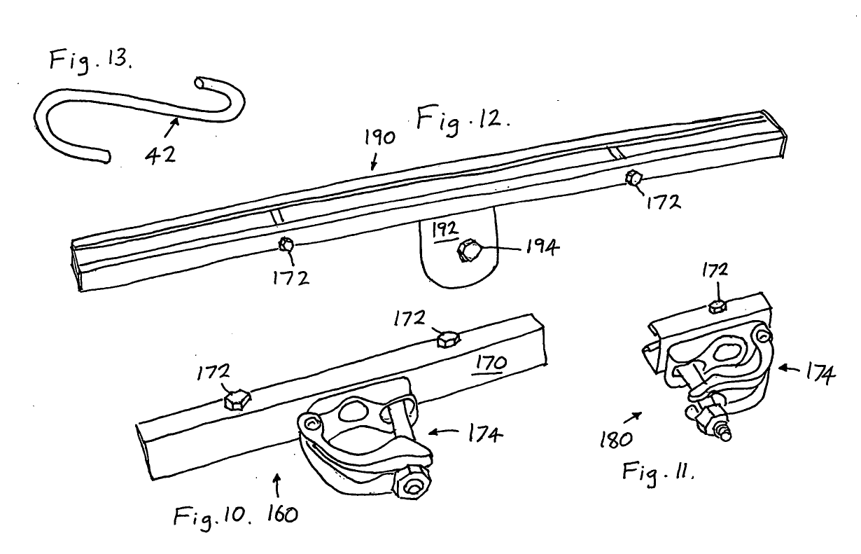

In FIGS. 9 and 10 there is shown an electrical lead retainer 160 in accordance with yet another embodiment of the present invention. The electrical lead retainer 160 is similar to the electrical lead retainer 10 and like numerals denote like parts. The electrical lead retainer 160 differs from the electrical lead retainer 10 in that it has two body halves 162 and 164 that are E-shaped with a centrally located support tongue 166. The body halves 162 and 164 sandwich a web 168 that has two sets of three holes 30.

The electrical lead retainer 160 allows for up to six electrical leads 32 to be retained.

The electrical lead retainer 160 also has a frame 170 that is substantially channel shaped for receiving the body halves 162 and 164. Typically, bolts 172 are used to fix the body halves 162 and 164 into the frame 170. For this purpose the body haves 162 and 164 have holes similar to the hole 150 of the retainer 140. The frame 170 also has a clamp 174 conveniently of the kind commonly know and used in the erection of scaffolding.

The clamp 174 allows the electrical lead retainer 160 to be secured to a pipe 176 such as used in scaffolding at a building or construction site.

In FIGS. 11 to 12 there is shown further embodiments of a frame 180 and 190, respectively for smaller body halves 12, 14 and larger body halves 162, 164. The frame 190 also has a pipe end 192 with a grub screw 194 for securing the frame 190 atop a pipe.

It is also envisaged that the pipe end 192 could fixed to the side of the frame 190. In this case the pipe end 192 could be slid over a vertically oriented metals material reinforcing bar and secured with the grub screw 194 part way along the length of the reinforcing bar.

It is important to note that, since each retainer 10, 100, 140, 160 clamps onto the lead 32, the lead 32 is substantially inhibited from slipping in the hole 30 and therefore during installation of the lead 32 along a plurality of the retainers 10, 100, 140, 160 the lead 32 can be tensioned so as to reduce the amount of sag that otherwise occurs when elevating such leads 32.

In the past such tensioning was only achieved by tying the lead 32 about a piece of scaffolding or to the T-support. Such tying is dangerous and tends to result in damage to the lead 32.

The electrical lead retainer 10, 100, 140, 160 can be attached to various structures commonly found on building, mine and construction sites—including scaffolding tubes, angle iron, door frame, roof supports, guttering, posts, reinforcing bars and the like.

By the use of the cord retainer 10, 100, 140, 160 of the present invention cords 32 can be suspended above the ground or floor and inhibited from sliding with respect to the cord retainer 10, 100. Also, a plurality of cords 32 can be suspended by one of the cord retainers 10, 100, 140, 160.

When used with electrical leads 32 the cord retainer 10, 100, 140, 160 reduces the risk of electrical shock and electrocution. Also, since the leads 32 are suspended off the ground or floor they stay cleaner, are less prone to damage and have a longer serviceable life. Further, there is less risk of the hazard of workmen tripping over the leads 32. Still further, the leads 32 can each be tensioned to substantially reduce sag in the lead 32 between adjacent retainers 10, 100, 140, 160 and thus reduces the need for workmen to stoop under the leads 32.

Modifications and variations such as would be apparent to a skilled addressee are considered within the scope of the present invention. For example, a rope or cable tie or the like could be used to attach the electrical lead retainer 10, 100, 140 to the beam 44. Also, a U-clamp could be used to attach the retainer 10, 100, 140 to a fixture in a semi permanent or permanent manner. Further, an electrical current detecting device could be associated with one or more of the holes 30 for detecting the presence or absence of an electrical current flowing in the electrical lead 32 and an indicator used to provide a visual indication of the flow of electrical current. An electrical coil could be moulded into the web 14 for the purpose of detecting the flow of electrical current in the leads 32.

1. A cord retainer for suspending a cord above the ground or floor, the cord retainer including a body, a clamp means depending from the body and a mounting means in operative association with the body, the clamp means being able to clamp the cord and retain it against substantial longitudinal movement with respect to the cord retainer, and the clamp means including a resilient retarding means for allowing limited displacement of the cord in its longitudinal direction.

2. A cord retainer for suspending a cord above the ground or floor, the cord retainer including a body, a resilient web depending from the body and a mounting means in operative association with the body, the resilient web including at least one aperture provided with a slit extending to an outer edge of the resilient web, the resilient web having a thickness greater than 50% of the radius of said aperture, the slit being arranged so that the resilient web can be deformed for allowing insertion of the cord into the aperture via the slit and therein the cord is substantially retained against longitudinal movement with respect to the resilient web, and the mounting means enabling the body to be suspended above the ground or floor.

3. A cord retainer according to claim 2, in which the aperture in the resilient web is between 5% to 15% smaller in diameter than the diameter of the cord.

4. A cord retainer according to claim 2, in which the width of the slit is less than 15% of the diameter of the hole.

5. A cord retainer according to claim 2, also including an insert for location about the cord to increase its diameter at the location of insertion into the aperture.

6. A cord retainer according to claim 2, in which the body includes finger elements disposed between adjacent apertures to support the resilient web and limit its resilient movement in the direction of length of the cord, the finger elements being substantially rigid and non-resilient.

7. A cord retainer according to claim 2, also including a frame member receiving the said body, the frame member having a clamp for attaching the cord retainer to afixture for disposing the cord above the ground or floor.

8. A cord retainer according to claim 7, in which the frame member has a channel for receiving the body and a fixing means for attaching the body to the frame member.
